(19) United States
(12) Patent Application Publication
(10) Pub. No.: US 2013/0132207 A1
(43) Pub. Date: May 23, 2013

(54) INFORMATION SERVICE FOR FACTS EXTRACTED FROM DIFFERING SOURCES ON A WIDE AREA NETWORK WITH TIMELINE DISPLAY

(71) Applicant: Christopher Ahlberg, Watertown, MA (US)

(72) Inventor: Christopher Ahlberg, Watertown, MA (US)

(21) Appl. No.: 13/621,156

(22) Filed: Sep. 15, 2012

Related U.S. Application Data
(62) Division of application No. 12/156,455, filed on May 29, 2008, now abandoned.
(60) Provisional application No. 61/068,967, filed on Mar. 11, 2008.
(60) Provisional application No. 60/940,643, filed on May 29, 2007.

(51) Int. Cl. G06F 17/30

(52) U.S. Cl. CPC G06F 17/30595; G06Q 30/0241
USPC 705/14.71; 707/736; 705/14.4

(57) ABSTRACT

In one general aspect, a wide area network fact information service system is disclosed. It includes a real time database that stores information about facts on the network by recording at least an identifier and an occurrence timepoint for each fact, with the occurrence timepoint identifying a time at which the fact occurred. It also includes fact-based expression logic operative to interact with expressions that define relationships between facts based on both their identifiers and their timepoints, and a timeline display interface operative to display a timeline that shows a temporal relationship between facts.

### CROSS-REFERENCE TO RELATED APPLICATION

This application is a divisional of U.S. application Ser. No. 12/156,455 filed May 29, 2008, which claims the benefit under 35 U.S.C. 119(e) of U.S. provisional application Ser. No. 61/068,967, filed Mar. 11, 2008 and U.S. provisional application Ser. No. 60/940,643; filed May 29, 2007. This application is also related to another divisional application being filed today and having the same title as this application. All of these related applications are herein incorporated by reference.

### FIELD OF THE INVENTION

This application relates to information services, such as information services for facts extracted from content meaning across differing sources on a wide area network. Content meaning can be derived through linguistic analysis, metadata, or other approaches.

### BACKGROUND OF THE INVENTION

Many approaches for extracting and using information from large networking environments, such as the Internet, have been proposed and implemented. Search engines and manually generated indexes are among the most common tools used for this purpose today, but there are literally hundreds of other specialized and/or complex data mining techniques that have been developed. And a large amount of effort is constantly being expended to improve and reengineer existing approaches as well as to develop new ones.

### SUMMARY OF THE INVENTION

In one general aspect, the invention features a network fact information service system, including a real time database that stores information about facts on the network by recording at least an identifier and an occurrence timepoint for each fact, wherein the occurrence timepoint identifies a time at which the fact occurred, fact-based expression logic operative to interact with expressions that define relationships between facts based on both their identifiers and their timepoints, and a timeline display interface operative to display a timeline that shows a temporal relationship between facts.

In preferred embodiments, the timeline display interface can be operative to present scheduled future facts on the timeline. The system can further include storage for future facts and current facts. The system can further include prediction logic operative to generate predictions of future facts. The timeline display interface can present at least one predicted future fact and graphically shows a temporal relationship between facts. The timeline display interface can be operative to present likelihood indicators in association with the presentation of predicted future facts. The timeline display interface can be operative to present relatedness indicators that visually indicate an association between correlated facts. The system can further include an advertizing engine operative to associate advertizing with past, current, or future facts. The advertizing can engine includes a reverse auction engine that can set prices based on a length of a time period before a fact, wherein shorter periods are associated with higher costs.

In another general aspect, the invention features a wide area network fact information service system that includes a fact information extraction interface operative to extract information about facts from different kinds of textual sources that include information about those facts, a database that stores at least some of the extracted information about the facts from the different types of information by recording at least an identifier and an occurrence timepoint for each fact, wherein the occurrence timepoint identifies a time at which the fact occurred, ranking logic operative to associate a ranking with at least some of the facts, and a service interface operative to enable a service consumer to access the stored facts based on at least their timepoints and their associated rankings.

In preferred embodiments, the service interface can be available via the internet. The system can further include timepoint extraction logic operative to extract the occurrence timepoints for the facts from documents on the network. The fact-based network interaction engine can include search logic operative to find facts that satisfy one or more of the expressions. The fact-based network interaction engine can include search logic operative to find sets of facts that satisfy one or more of the expressions. The search logic can be operative to find one or more past, current, and/or future facts. The fact-based network interaction engine can include monitoring logic operative to find one or more sets of facts that satisfy one or more of the expressions as they occur. The fact-based network interaction engine can include monitoring logic operative to find one or more sets of facts that satisfy one or more of the expressions as they occur. The fact-based network interaction engine can include personal fact aggregation logic operative to aggregate facts for a user based on one or more of the expressions. The fact-based network interaction engine can be applied to news stories. The system can further include sending logic operative to issue an alert or message when one or more of the expressions is satisfied. The alert or message can be machine-readable. The alert or message can be human-readable. The alert logic can issue the alerts or messages using an RSS format. The fact-based network interaction engine can include logic operative to define actions to be taken based on the detected sets. The actions can include the initiation of a commercial transaction. The actions can include the initiation of a security purchase transaction. The fact-based network interaction engine can further include logic operative to automatically initiate the actions. The actions can include financial transactions. The facts can be stored and monitored in real-time. The facts can include news flashes, blog modifications, weather data, or organizational information releases. The facts can be scraped of the internet, read from RSS feeds, or gained/uploaded through other sources. The database can be part of a scalable relational data warehouse. The network can be the internet. The service interface can include a list display interface that is operative to display a ranked list of results. The identifier can include information about both source and content for the fact. The identifier can include meta-data for the fact. The service interface can be a user interface to allow human end users to interact with the service as service consumers. The service interface can be a software interface to allow software to interact with the service as service consumers. The system can be operative to select facts to store information about based on input from the service consumer. The system can be operative to interact with information about facts from a plurality of different types of sources. The fact system can be operative to interact with facts from RSS feeds. The system can further include a search expression sales interface operative to allow service consumers to purchase predefined search expressions. The system can further include an entity extractor. The entity extractor can be operative to extract some information about facts based on formal linguistic processing and some information about facts based on entity-verb clustering. Fact information can be stored in a real time cache for a predetermined amount of time and then be moved to the database. The service interface can include display logic operative to display information about the facts in a continuously updated sub-area of a computer display. The service interface can include display logic operative to display information about the facts in a sub-area of a computer display and wherein the area is operative to display information relating to entities and/or facts for which information is displayed in another sub-area of the computer display. The service interface can include a timeline display interface operative to display a timeline that shows a temporal relationship between facts. The timeline display interface can be operative to update the timeline in real time as new future facts occur or are predicted. The timeline display interface can display the temporal relationships graphically. The service interface can be operative to present scheduled or predicted future facts on the timeline. The system can further include storage for future facts and current facts. The system can further include prediction logic operative to generate predictions or inferences of future facts. The system can further include the ability for end users to submit predictions and their likelihood of occurring to the database. The ranking logic can be operative to derive rankings based on a third party source document ranking. The ranking logic can be operative to derive rankings based on occurrence position in a document. The ranking logic can be operative to derive rankings for information about facts based on the source of that information. The service interface can includes timeline display interface operative to display a timeline that presents at least one predicted future fact and graphically shows a temporal relationship between facts. The timeline display interface can be operative to update the timeline in real time as new future facts occur or are predicted. The timeline display interface can be operative to present likelihood indicators in association with the presentation of predicted future facts. The timeline display interface can be operative to present relatedness indicators that visually indicate an association between correlated facts. The system can further include ontology management logic operative to maintain an ontology for classifying the information about facts. The fact information extraction interface can be operative to extract estimated timepoints.

In a further general aspect, the invention features a network fact information service system that includes a real time database that stores information about facts on the network by recording at least an identifier and an occurrence timepoint for each fact, wherein the occurrence timepoint identifies a time at which the fact occurred, fact-based expression logic operative to interact with expressions that define relationships between facts based on both their identifiers and their timepoints, a relationship database for storing representations of the relationships that satisfy the expressions, and a service interface operative to allow a service consumer to query the database of stored relationships.

In preferred embodiments, the fact-based expression logic can be operative to define different types of relationships, with the relationship database being operative to store information identifying a type for at least some of the representations of relationships, and with the service interface being responsive to queries that include relationship type identifiers. The service interface can include a timeline display interface operative to display a timeline that graphically shows a temporal relationship between facts. The service interface can be operative to present scheduled future facts on the timeline. The system can further include storage for future facts and current facts. The system can include prediction logic operative to generate predictions of future facts. The service interface can include a timeline display interface operative to display a timeline that presents at least one predicted future fact and graphically shows a temporal relationship between facts. The timeline display interface can be operative to present likelihood indicators in association with the presentation of predicted future facts. The timeline display interface can be operative to present relatedness indicators that visually indicate an association between correlated facts.

Systems according to the invention can be beneficial in that they can allow users to approach temporal information about facts in new and powerful ways, enabling them to search, analyze, and trigger external events based on complicated relationships in their past, present, and future temporal characteristics.

### BRIEF DESCRIPTION OF THE DRAWINGS

FIG. 1 shows a conceptual block diagram for an illustrative system according to the invention;

FIG. 2 shows a layer-based model for systems according to the invention;

FIG. 3 shows a block diagram of an embodiment of an illustrative system. According to the invention; and

FIG. 4 is a conceptual data diagram for use with systems according to the invention.

### DETAILED DESCRIPTION OF AN ILLUSTRATIVE EMBODIMENT

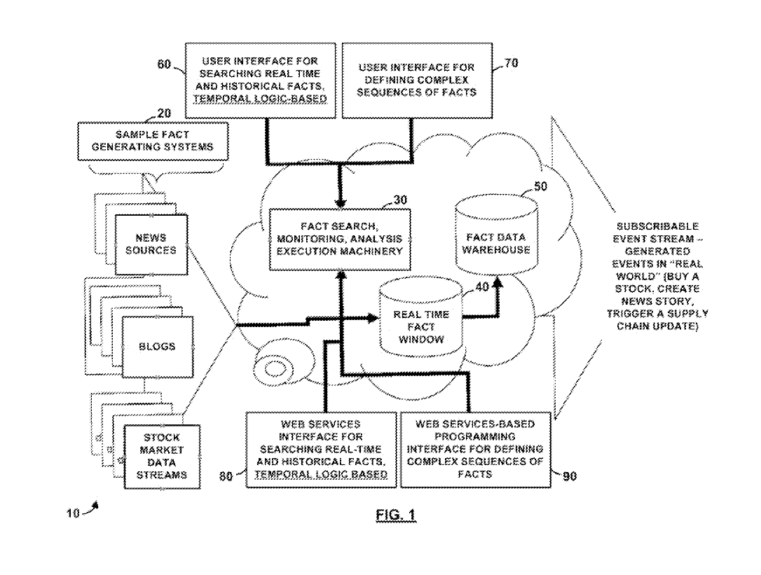

Referring to FIG. 1 an illustrative embodiment of a system 10 according to the invention can include one or more sources 20 of information about facts. In the case of the Internet, the information about facts can be retrieved from a wide variety of sources, such as news feeds, newspapers and magazines, blogs, websites, corporate calendars, political calendars, weather, sensor data, and stock market data streams. These are, of course, only examples of the types of data sources that can be used, and the concepts and principles presented in connection with the invention can be applied to other types of data sources, such as private networks, government data services, or enterprise/industrial automation tools.

The system 10 can also include research, monitoring, analysis, and execution machinery 30, which is responsive to the information sources 20. This part of the system can cooperate with a fact data warehouse 50, as well as several external interfaces. A data cache 40 can also be provided to speed up data retrieval in certain circumstances.

The external interfaces include a user interface, which is temporal logic based, for searching historical, present, and future facts 60, and a user interface for defining complex sequences of facts 70. The external interfaces also include a Web services interface, which is temporal logic based, for searching historical, present, and future facts 80, and a Web services-based programming interface for defining complex sequences of facts 90. The system 10 can also generate a “subscribable” fact stream for generated facts in the “real world” (e.g., buying a stock, creating a news story, triggering a supply chain update).

Facts are pieces of information about occurrences that can take place anywhere and can then be described, reported, or otherwise manifested or revealed in some form on a computer network. A sports feed can report facts for a game, for example, such as by updating a score tally. A sports blog can also focus on different facts from the same game and/or can describe the same facts from the same game in different ways.

The facts themselves can also be network-based. In the case of an electronic corporate securities filing, for example, the occurrence on the network of the filing itself can be a fact. And it can also act as a source of descriptive material for facts that it describes, such as a company's product release dates.

The existence of facts and information about them are typically acquired by applying software such as entity and event extractors to text documents/sources. One approach to extraction is to linguistically analyze plain text, such as through the use of services from Reuters, ClearForest, InXight, and/or Attensity. Extraction can also involve simple harvesting where the content already contains meta-data, such as Resource Description Framework (RDF) tags.

If, for example, an article includes the following sentence:

“Fort Orange financial completes $3.3M stock offering.”

the system can use linguistic analysis to map the document date to the investment fact. Note that in some circumstances, techniques amounting to less-than-perfect linguistic analysis, such as entity-verb clustering, can be used without excessive loss of performance.

In another example, an article includes the following sentence:

“Look for a barrage of shareholder lawsuits against Yahoo next week”

In this case, the system can map the lawsuit fact to a “next week” timepoint (a scheduled future fact).

Future facts can be scheduled facts, such as the expected Yahoo lawsuits or events extracted from an Internet calendar. They can also be predicted based on a variety of prediction methods. These can range from complex statistical forecasting methods to simple inferences, such as where a company's next annual meeting is predicted to be on the same day as all of its past annual meetings.

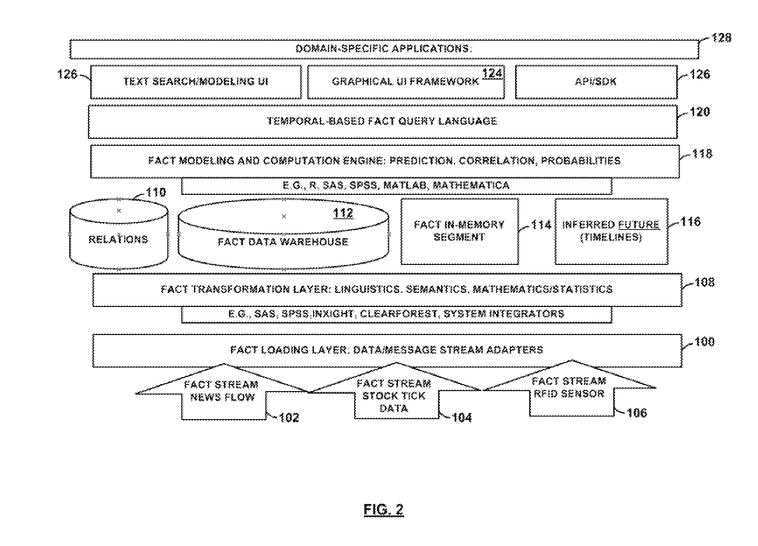

Referring to FIG. 2, a system according to the invention can be organized according to a layered model. At the lowest level is a fact loading layer 100 that includes data/message stream and adapters. These receive data and/or message streams, such as news flow fact streams 102, stock tick data fact streams 104, and/or RFID sensor fact streams 106.

Above the fact loading layer 100 is a fact transformation layer 108, which can operate based on linguistics, semantics, and/or mathematics/statistics. Above the fact transformation layer is relations storage 110, a fact data warehouse 112, and fact in-memory segment 114 (cache), and an inverted future (timelines) module 116. At the next level is a fact modeling and computation engine 118, which can work with prediction, correlation, and probabilities. Layered above the fact modeling and computation engine is a temporal-based fact query language 120. A text search/modeling user interface 122, a graphical user interface framework 124, and an application programming interface/software development kit 126 are all layered over the temporal-based fact query language. Domain-specific applications 128 are in turn layered above these modules.

Examples of domain-specific applications can include:
a dynamic yearbook generator for Facebook that shows who dated who.
an inference/correlation generated newspaper
inference/correlation generated market data
inference/correlation generated “most wanted

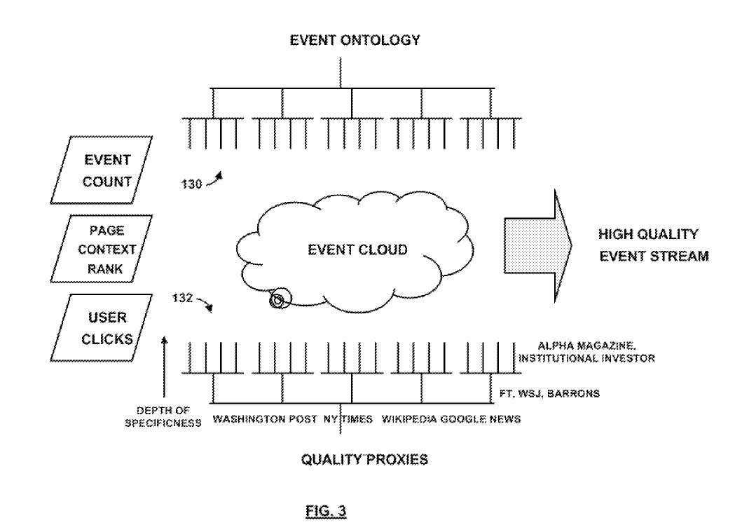

Referring to FIG. 3, the system can be based on fact ontology 130 that categorizes facts into categories and subcategories, such as financial information and types of financial transactions, and a source ontology 132 that categorizes sources. The system also maintains fact counts, page context rank, and user click counts to be used in qualifying fact information. These are used to categorize and rank facts and information about facts. A newspaper article from a reputable newspaper, for example, will be ranked higher than an unknown blog entry for the same facts and/or entities. The categorization of facts and information about facts is similarly used to determine the relevance of a database entry to a service request, such as a search query. The overall ranking in relation to the service request will determine which database entries are selected and in what order they are presented to the user.

The system can present its results to the user in a variety of formats. It can present them in a simple hit list-based result output, similar to that of a traditional search engine, or it can use a temporally oriented format, such as a timeline. It can also use any other suitable user-oriented or machine-oriented format, such as more elaborate graphical user interfaces, RSS feeds, e-mail alerts, XML documents, or proprietary binary formats. Advertising can be associated with results, and this advertising can be targeted based on the specific facts and/or entities involved.

The system can provide a variety of types of services. A fact-based searching system can be provided for use by the general public or a specific segment. Fully customized, minimally filtered, or even raw fact feed subscriptions can also be provided. And more quantitative searching solutions could be provided, as well, such as for financial services applications.

One type of service is a news service. The service receives a user profile, which allows a user to specify interests. Information about facts relevant to these interests can then be provided to the user in a variety of formats, such as feeds, or an electronic newspaper format.

Mapping facts to temporal information in the database allows the system to answer questions that may be difficult to answer with traditional search engines. Here are some examples:

What will the pollen situation be in Boston next week?

Will terminal five be open next month?

What's happening in New York City this week?

When will movie X be released?

When is the next SARS conference?

When is Pfizer issuing debt next?

Where Will George Bush be next week?

Systems according to the invention can also answer more complex questions about the relationship between facts, such as “what happened to similar entities in similar chains of events?”

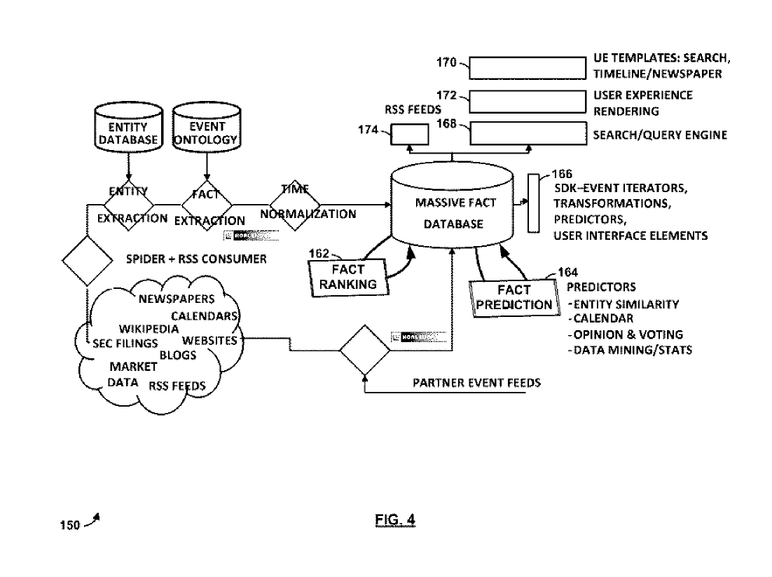

Referring to FIG. 4, in one embodiment of a system 150, information sources are accessed through spiders and RSS subscriptions. An entity extraction module 152 and a fact extraction module 154 extract entity and fact information based on an entity database 154 and fact ontology storage 156. The resulting information is time-normalized (158) and stored in a large-scale fact database 160. This database can be partitioned based on the fact ontology. Fact ranking and fact prediction processes 162, 164 can be used to augment the database with ranking and predictive information. Entities can include a wide variety of subjects, such as people, places, or timepoints.

A software development kit 166 allows developers to iterate facts, perform transformations and predictions, and implement user interface elements. The system can also provide a search/query engine 168 as well as user experience templates 170 and rendering 172 to produce different types of interfaces, such as search, timeline, and newspaper interfaces. RSS feeds 174 can also be generated from the database.

The system described above has been implemented in connection with a special-purpose software program running on a general-purpose computer platform, but it could also be implemented in whole or in part using special-purpose hardware. And while the system can be broken into the series of modules and steps shown in the various figures for illustration purposes, one of ordinary skill in the art would recognize that it is also possible to combine them and/or split them differently to achieve a different breakdown.

The present invention has now been described in connection with a number of specific embodiments thereof. However, numerous modifications which are contemplated as falling within the scope of the present invention should now be apparent to those skilled in the art. It is therefore intended that the scope of the present invention be limited only by the scope of the claims appended hereto. In addition, the order of presentation of the claims should not be construed to limit the scope of any particular term in the claims.

What is claimed is:

1-63. (canceled)

64. A network fact information service system, including:
a real time database that stores information about facts on the network by recording at least an identifier and an occurrence timepoint for each fact, wherein the occurrence timepoint identifies a time at which the fact occurred,
fact-based expression logic operative to interact with expressions that define relationships between facts based on both their identifiers and their timepoints, and
a timeline display interface operative to display a timeline that shows a temporal relationship between facts.

65. The system of claim 64 wherein the timeline display interface is operative to present scheduled future facts on the timeline.

66. The system of claim 64 further including storage for future facts and current facts.

67. The system of claim 64 further including prediction logic operative to generate predictions of future facts.

68. The system of claim 67 wherein the timeline display interface presents at least one predicted future fact and graphically shows a temporal relationship between facts.

69. The system of claim 68 wherein the timeline display interface is operative to present likelihood indicators in association with the presentation of predicted future facts.

70. The system of claim 68 wherein the timeline display interface is operative to present relatedness indicators that visually indicate an association between correlated facts.

71. The system of claim 68 further including an advertizing engine operative to associate advertizing with past, current, or future facts.

72. The system of claim 71 wherein the advertizing engine includes a reverse auction engine that sets prices based on a length of a time period before a fact, wherein shorter periods are associated with higher costs.
